(19) United States
(12) Patent Application Publication
(10) Pub. No.: US 2010/0095662 A1
(43) Pub. Date: Apr. 22, 2010

(54) RECHARGEABLE RECIPROCATING PNEUMATIC PISTON ENGINE

(76) Inventor: Julio Chavez, Jupiter, FL (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/640,441

(22) Filed: Dec. 17, 2009

Related U.S. Application Data
(63) Continuation-in-part of application No. 12/207,606, filed on Sep. 10, 2008.

(51) Int. Cl. F16D 31/02

(52) U.S. Cl. 60/370

(57) ABSTRACT

A rechargeable pneumatic reciprocating piston engine that uses a mixture of compressed air and water as the working fluid with a combination of gravity and spring force functioning to return the piston after completion of the power stroke whereafter repeated power strokes may be achieved from a single charge of compressed fluid thereby providing a rechargeable pneumatic engine capable of running for an extended period of time on a single charge is disclosed.

### CROSS REFERENCE TO RELATED APPLICATIONS

This application is a continuation-in-part of U.S. patent application Ser. No. 12/207,606, filed on Sep. 10, 2008.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all rights whatsoever.

### BACKGROUND OF THE INVENTION

1. Field of the Invention

The present invention relates generally to reciprocating piston engines, and more particularly to a rechargeable pneumatic engine wherein a mixture of compressed air and water functions as the working fluid, with a combination of gravity and spring force functioning to return the piston after completion of the power stroke.

2. Description of Related Art

An internal combustion engine is one in which combustion of the fuel takes place in a confined space, producing expanding gases that are used directly to provide mechanical power. Such engines are classified as reciprocating or rotary, spark ignition or compression ignition, and two-stroke or four-stroke. The most familiar combination is the reciprocating, spark-ignited, four-stroke gasoline engine, commonly found in automobiles.

The first person to experiment with an internal-combustion engine was the Dutch physicist Christian Huygens, about 1680. But no effective gasoline-powered engine was developed until 1859, when the French engineer J. J. Étienne Lenoir built a double-acting, spark-ignition engine that could be operated continuously. In 1862 Alphonse Beau de Rochas, French scientist, patented but did not build a four-stroke engine; sixteen years later, when Nikolaus A. Otto built a successful four-stroke engine, it became known as the “Otto cycle.” The first successful two-stroke engine was completed in the same year by Sir Donald Clerk, in a form which (simplified somewhat by Joseph Day in 1891) remains in use today. In 1885 Gottlieb Daimler constructed what is generally recognized as the prototype of the modern gas engine: small and fast, with a vertical cylinder, it used gasoline injected through a carburetor. In 1889 Daimler introduced a four-stroke engine with mushroom-shaped valves and two cylinders arranged in a V, having a much higher power-to-weight ratio; with the exception of electric starting, which would not be introduced until 1924, most modern gasoline engines are descended from Daimler's engine.

The most common internal-combustion engine is the piston-type gasoline engine used in most automobiles. The confined space in which combustion occurs is called a cylinder. The cylinders are now usually arranged in one of four ways: a single row with the centerlines of the cylinders vertical (in-line engine); a double row with the centerlines of opposite cylinders converging in a V (V-engine); a double zigzag row somewhat similar to that of the V-engine but with alternate pairs of opposite cylinders converging in two V's (W-engine); or two horizontal, opposed rows (opposed, pancake, flat, or boxer engine). In each cylinder a piston slides up and down. One end of a connecting rod is attached to the bottom of the piston by a joint; the other and of the rod clamps around a bearing on one of the throws, or convolutions, of a crankshaft; the reciprocating (up-and-down) motions of the piston rotate the crankshaft, which is connected by suitable gearing to the drive wheels of the automobile. The number of crankshaft revolutions per minute is called the engine speed. The top of the cylinder is closed by a metal cover (called the head) bolted onto it. Into a threaded aperture in the head is screwed the spark plug, which provides ignition.

A significant disadvantage present with the use of internal combustion engines that burn hydrocarbon fuel is the resulting pollution. In order to meet U.S. government restrictions on exhaust emissions, automobile manufacturers have had to make various modifications in the operation of their engines, primarily to reduce the emission of nitrogen oxides and other toxic substances. The pollution generated by conventional internal combustion engines has spurred the development of engines capable of delivering power while significantly reducing, or entirely eliminating, polluting emissions.

U.S. Pat. No. 289,250, issued to Goyne discloses an operating valve for steam pumps wherein the piston is caused to flow forward and backward power strokes when the cylinder impacts piston L thereby moving slide valve C such that steam enters the opposite side of the piston.

U.S. Pat. No. 371,636, issued to Snow, discloses a Steam Bell Ringer wherein a suspended bell is swung by the thrust of a piston of a single acting engine wherein the steam-inlet is closed and the exhaust passage opened early in the stroke. Snow discloses use of a “three-winged puppet valve,” referenced as “V” for controlling the admission of steam under the piston. The tail of valve “V” extends into the cylinder cavity so as to be struck by the piston in its decent thereby opening the valve.

U.S. Pat. No. 384,095, issued to Snow, discloses a Steam Bell Ringer wherein further improvements are disclosed. Steam is admitted under piston “B” to drive same upward to the upper end of its stroke until its momentum is spent whereafter “gravity” will cause it to descend.

U.S. Pat. No. 3,079,900, issued to Hunnicutt, discloses a fluid motor having an automatically operable servo valve that is directly responsive to pressure conditions and the position of the piston within the displacement chamber. A piston is resiliently biased toward one end of the cylinder by a compression spring. Compression spring functions to move the piston to its starting position where the face contacts an extending nose portion of poppet valve. Engagement of the poppet valve allows air to enter though conduit and throttle valve.

U.S. Pat. No. 6,006,517, issued to Kownacki et al., discloses a fluid engine wherein a valve rod is movably housed to open a valve opening and close exhaust apertures during the piston's power stroke.

U.S. Pat. No. 6,073,441, issued to Harju, discloses a pneumatic piston/cylinder apparatus which performs a single working stroke in one working direction, and is returned to its initial position without any external supply of compressed air by using a second compressed air channel to return the piston to its initial position.

Many of the references in the background art rely on steam as the working fluid. The use of steam as a working fluid requires a steam generating apparatus, such as a boiler capable of producing high pressure steam. Use of a high pressure steam boiler, however, is considered undesirable due to complexity and the danger associated with high pressure steam. Furthermore, the high temperature associated with steam requires components capable of withstanding such temperatures further complicating the apparatus. Accordingly, there exists a need for a pneumatic reciprocating piston engine that uses a safe and reliable working fluid, other than steam.

A further complication recognized with fluid motors has been the development of a reliable pneumatic reciprocating motor having simplified mechanics that provide reliable automatic cycling. The references in the art disclose overly complex valve and control structures that increase cost and degrade reliability. The references disclosed in the art simply fail to provide a reliable pneumatic reciprocating piston motor. Accordingly, there exists a need for an improved pneumatic reciprocating piston motor capable of powering a wide variety of devices.

A further disadvantage with fluid motors of the background art involves the inability to run for a significant period of time on a single charge of pressurized fluid. Accordingly, there exists a need in the art for a rechargeable pneumatic engine capable of ramming for an extended period of time on a single charge.

### BRIEF SUMMARY OF THE INVENTION

The present invention overcomes the limitations and disadvantages present in the art by providing an improved pneumatic reciprocating piston engine that uses a mixture of compressed air and water as the working fluid with a combination of gravity and spring force functioning to return the piston after completion of the power stroke whereafter repeated power strokes may be achieved from a single charge of compressed fluid thereby providing a rechargeable pneumatic engine capable of running for an extended period of time on a single charge.

A working fluid, preferably comprising a source of compressed air, is in fluid communication with the bottom portion of a generally vertically disposed cylinder via an inlet valve biased to a normally closed position. A piston is configured for reciprocating motion within the cylinder and traverses between bottommost and topmost positions. The piston is configured to engage the inlet valve when at the bottommost position thereby actuating the valve for a limited period of time to an open position so as to allow the introduction of compressed air and initiating of the power stroke to drive the piston upward. In a preferred embodiment, water is injected into the compressed air stream entering the cylinder to provide lubrication for the piston. The piston is driven upward by the working fluid until an uppermost stop is reached wherein the piston head has cleared a fluid exhaust port formed in the cylinder thereby allowing the working fluid to escape whereby the fluid travels through a closed loop circuit including a plurality of spaced check valves and a heat exchanger for absorbing heat from the surrounding environment ultimately directing pressurized fluid back into the cylinder inlet. A mass is connected to the piston, in overhead relation, by a spring connection. When the piston reaches the uppermost stop, momentum causes the spring connected mass to continue upward thereby placing the spring in compression and maintaining the piston above the exhaust port so as to allow escape of the working fluid therethrough. Return of the mass downward, caused both by gravity and spring energy, causes the mass to engage the piston and return the piston to its bottommost position whereby another stroke is initiated. Power output may be transferred to any suitable system.

As the piston approaches top dead center, fluid is allowed to escape into a fluid return circuit via a cylinder exhaust port which incorporates a cheek valve to ensure one-way travel. The fluid return circuit includes, in the direction of flow, a pneumatic booster pump actuated by the return movement of the main piston to increase the pressure of the fluid. The booster cylinder output is in communication with the inlet of a heat exchanger that allows the expanding gas to absorb heat from the surrounding environment thereby providing beneficial cooling. The heat exchanger outlet is fluid communication with a remainder of the fluid return circuit including a plurality of spaced check valves that function to maintain pressure within the return circuit by preventing reverse flow. The fluid return circuit terminates at an inlet valve biased to a normally closed position.

Accordingly, it is an object of the present invention to provide an improved pneumatic reciprocating piston engine that uses a mixture of compressed air and water as the working fluid with a combination of gravity and spring force functioning to return the piston after completion of the power stroke.

Another object of the invention is to provide a rechargeable pneumatic engine capable of running for an extended period of time on a single charge.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a schematic illustration of a pneumatic reciprocating piston engine with the piston at bottom dead center;

FIG. 2 is a schematic illustration showing the piston in mid-stroke; and

FIG. 3 is a schematic illustration showing the piston at top dead center.

### DETAILED DESCRIPTION OF THE INVENTION

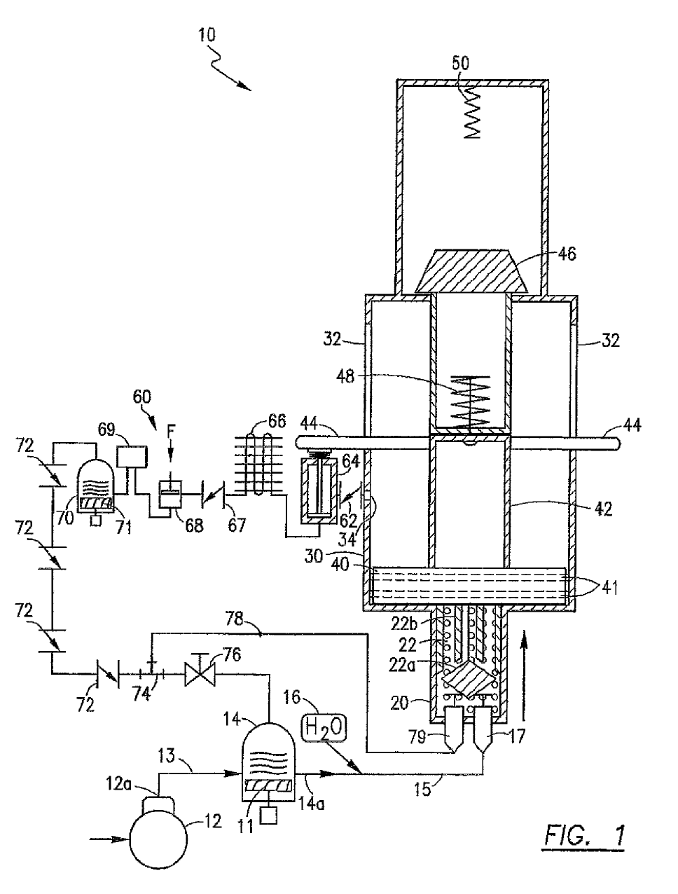

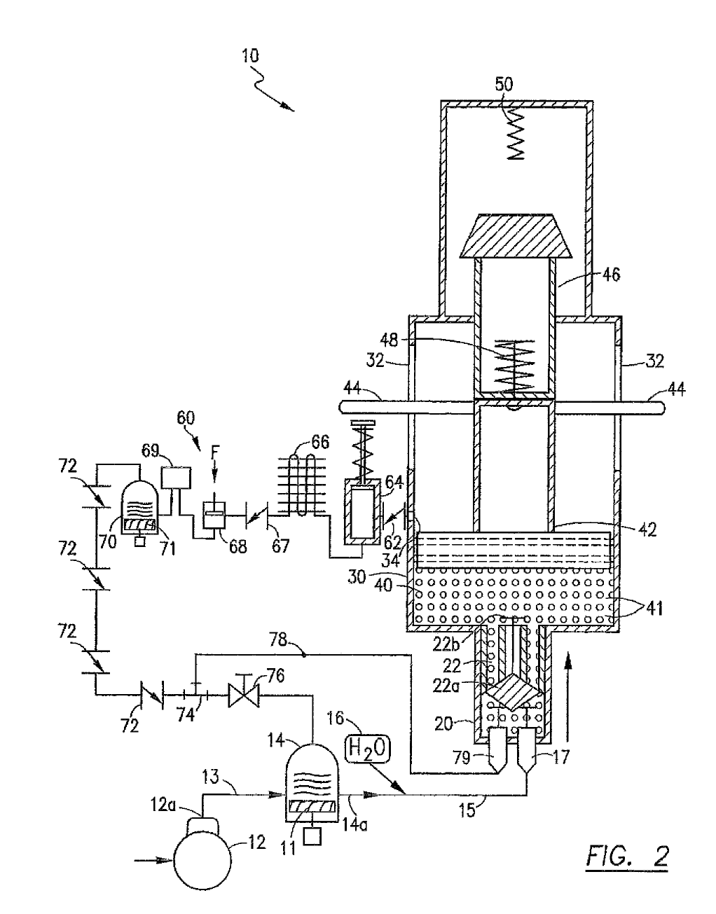

With reference now to the drawings, FIGS. 1-3 depict an improved pneumatic reciprocating piston engine, generally referenced as 10, in accordance with the present invention. Pneumatic engine 10 is powered by a mixture of compressed air and water. A compressor 12 has an outlet 12a in fluid communication with a pressure vessel 14 via a compressed gas line 13. Pressure vessel 14 includes a fan 11, such as a squirrel cage type blower, that functions to increase pressure while thoroughly mixing the water and air. Pressure vessel 14 has an outlet 14a in fluid communication with a cylinder intake, generally referenced as 20, via a compressed gas line 15 terminating in a valve 17. Valve 17 comprises a normally closed valve. In a preferred embodiment, the compressed gas is air, however, the use of an alternate gas (such as Nitrogen) is considered within the scope of the present invention. A water source 16 is also in fluid communication with gas line 15 so as to provide a mixture of compressed air and water/water vapor to cylinder intake 20. Injecting a relatively small amount of water, or other suitable liquid, into the compressed air supply has been found to unexpectedly increase the work extracted from the compressed air. In addition, the water functions as a lubricant for the reciprocating piston.

Cylinder intake 20 is in fluid communication with a cylinder 30. Intake 20 includes a check valve 22 having a movable element 22a that controls the flow of the compressed gas and water mixture into pneumatic engine 10. As used herein, the term “check valve” shall broadly refer to any valve structure capable of actuation between open and closed positions, including biased valves intended to restrict flow to a single direction. Check valve 22 is maintained in a normally closed position by compressed air from the compressed air source. Check valve 22 is actuated from its normally closed position by forced downward movement of stem 22b that projects upward from intake 20 into cylinder 30, and returns to the normally closed position as the piston moves upward. As more fully discussed below, actuation of check valve 22 is caused by engagement of a piston 40 as it returns to the bottom dead center position shown in FIG. 1 Check valve 22 further functions to actuate valve 17 to an open position. More particularly, moveable element 22a of check valve 22 functions, upon opening by downward movement, to engage valve 17 thereby actuating it to an open configuration to allow for the introduction of pressurized fluid (e.g. air).

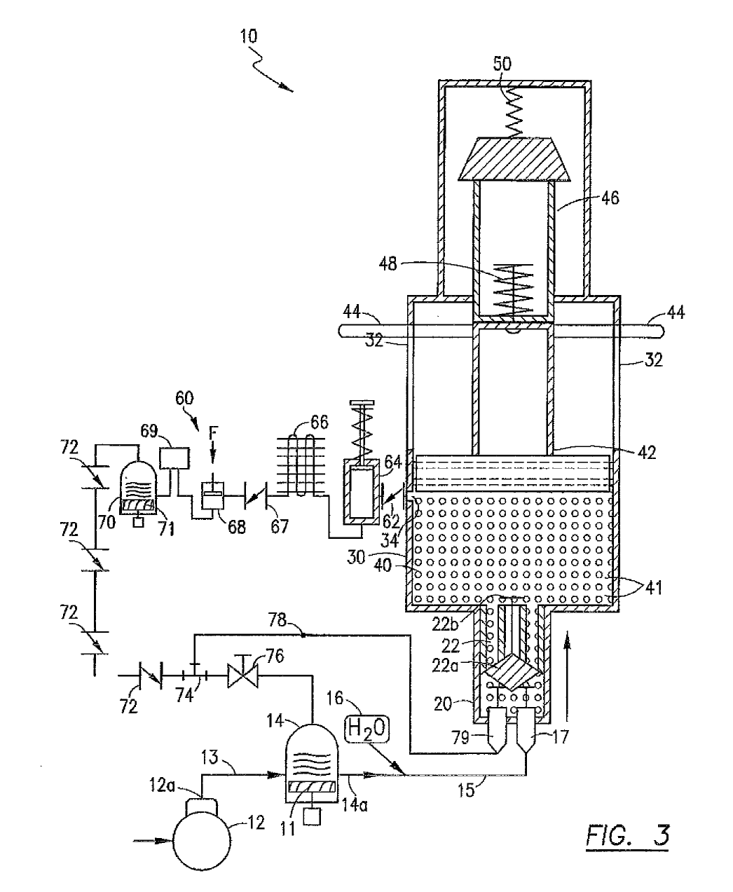

Piston 40 includes peripheral seals 41, and a connecting rod 42 fixed thereto that projects vertically upward therefrom. Connecting rod 42 preferably includes laterally extending reciprocating rigid members 44 that function to transmit power from piston 40 to any suitable external power receiving source via elongate, vertically disposed slotted apertures 32 defined in the cylinder wall. Cylinder 30 further includes at least one exhaust port 34 to allow at least a portion of the compressed air and water mixture to exit into a fluid return circuit as more fully discussed below when the piston 40 is at the top dead center position depicted in FIG. 3. Exhaust port 34 may be structured such that water may pool therein and subsequently back flow into the cylinder above the piston to provide a source of lubrication. A mass assembly 46 is connected to connecting rod 42 by a spring connection 48 whereby mass assembly 46 may separate from connecting rod 42. More particularly as piston 40 travels upward, the top dead center position is reached when rigid members 44 reach the uppermost end of slotted apertures 32 formed in the cylinder wall thereby causing piston 40 to come to an abrupt stop. At the top dead center position, piston 40 has cleared exhaust port 34 sufficiently to allow for the escape of air thereby initiating the exhaust cycle.

As best seen in FIG. 3, once piston 40 reaches top dead center, momentum causes mass assembly 46 to separate from connecting rod 42 and continue traveling upward compressing spring 48 and an optional upper spring 50. Springs 48 and 40 function to dampen vibration resulting from piston 40 coming to an abrupt stop at top dead center. In addition, allowing mass assembly 46 to continue the momentum based upward travel functions to maintain piston 40 at the top dead center position for a period of time thereby allowing air to escape from cylinder 30 via exhaust port 34. Ultimately springs 48 and 50 along with the influence of gravity cause mass assembly 46 to travel downward. Once mass assembly 46 engages connecting rod 42, gravity functions to force piston 40 downward to bottom dead center wherein stem 22b of poppet valve 20 is automatically engaged thereby initiating the next power stroke.

Power is transferred from pneumatic engine 10 via reciprocating motion of projecting members 44. As should be apparent, work generated by engine 10 may be used to power any power consuming or receiving apparatus or system, including vehicles, generators, or any other suitable device.

Exhaust port 34 is preferably in fluid communication with a fluid return circuit, generally referenced as 60 via a cylinder exhaust port which incorporates a check valve 62 to ensure one-way travel. Fluid return circuit 60 includes, a pneumatic booster primp 64 actuated by the return stroke of piston 40 to increase the pressure of the fluid downstream of booster pump 64. Booster pump 64 has an outlet in fluid communication with the inlet of a heat exchanger 66 that allows the expanding gas to absorb heat from the surrounding environment thereby providing beneficial cooling. Heat exchanger 66 has an outlet in fluid communication with a check valve 67 and a second booster pump 68, that is preferably actuated by an external source. Second booster pump 68 has an outlet in fluid communication with a heat exchanger 69 which functions to raise the temperature of the fluid within return circuit 60. Heat exchanger 69 has an outlet in fluid communication with a pressure vessel 70 that provides an increased volume for containing pressurized fluid. Pressure vessel 70 includes a fan 71, such as a squirrel cage type blower, that functions to increase pressure while thoroughly mixing the water and air. Pressure vessel 70 has an outlet in fluid communication with a series of check valves 72 whereafter the fluid return circuit includes a T-connection 74. T-connection 74 includes a first outlet in fluid communication with a manually actuated valve 76 which in turn is in fluid communication with pressure vessel 14. T-connection 74 further includes a second outlet in fluid communication with a fluid line 78 which terminates at a normally closed valve 79 having an outlet in fluid communication with cylinder intake 20. Check valve 22 further functions to actuate valve 79 to an open position. More particularly, moveable element 22a of check valve 22 functions, upon opening by downward movement, to engage valve 79 thereby actuating it to an open configuration to allow for the introduction of pressurized fluid (e.g. air).

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A rechargeable reciprocating pneumatic piston gravity engine comprising:
a generally vertically disposed cylinder having a top end portion and a bottom end portion;
a piston received within said cylinder and capable of reciprocating movement between a top dead center (TDC) position and a bottom dead center (BDC) position, said piston performing a working stroke when moving from the BDC position to the TDC position, and returning to the BDC position from the TDC position under the influence of gravity;
to said cylinder defining an exhaust port;
a cylinder fluid intake including a valve in fluid communication with said cylinder bottom portion, said valve movable between a closed position and an open position, said valve including a actuating stem configured for actuating said valve when said piston reaches the BDC position;
said piston engaging said valve actuating stem upon returning to said BDC so as to actuate said valve to the open configuration whereby air from said compressed air source flows through said valve into said cylinder to initiate the working stroke;
a compressed air source in fluid communication a first pressure vessel, said pressure vessel having an outlet in fluid communication with a first a manually actuated normally closed valve having an outlet in fluid communication with cylinder fluid intake, and a valve actuator configured to actuate the valve as said piston returns to the BDC position;
a booster pump having an inlet in fluid communication with said exhaust port, and an outlet, said booster pump configured for actuation as said piston returns to the BDC position;
a fin and tube heat exchanger having a tube inlet in fluid communication with the outlet of said booster pump, and a tube outlet;
a second pressure vessel having an inlet in fluid communication with said tube outlet, and an outlet;
a plurality of spaced check valves disposed in series within a fluid conduit assembly having an first end in fluid communication with said second pressure vessel outlet and a second end tee at a T-connection having first and second outlets;
said first outlet in fluid communication with a manually actuated normally closed valve having an outlet in fluid communication with cylinder fluid intake, and a valve actuator configured to actuate the valve as said piston returns to the BDC position;
said second T-connection outlet in fluid communication with a manual valve having an outlet end in fluid communication with said first pressure vessel; and
whereby intermittent activation of said compressed air source provides a working fluid to drive said piston.

2. A rechargeable reciprocating pneumatic piston gravity engine according to claim 1, further including a water source in fluid communication with compressed air source for injecting at least some water into air entering said cylinder.

3. A rechargeable reciprocating pneumatic piston gravity engine according to claim 1, further including a rigid member connected to said piston and projecting though a slotted aperture in said cylinder, said rigid member reaching the end of said slotted aperture thereby engaging said cylinder at TDC thereby causing said piston to come to an abrupt stop.

4. A reciprocating pneumatic piston gravity engine according to claim 1, further including means for dampening vibration connected to said piston.

5. A reciprocating pneumatic piston gravity engine according to claim 4, wherein said means for dampening vibration includes a mass movably connected to said piston via a resilient connection.

6. A reciprocating pneumatic piston gravity engine comprising:
a generally vertically disposed hollow cylinder formed about a longitudinal axis, said cylinder having a top end portion and a bottom end portion and sidewall defining a slotted aperture;
a piston received within said cylinder and capable of reciprocating movement between a top dead center (TDC) position and a bottom dead center (BDC) position by a fluid, said piston performing a working stroke when moving from the BDC position to the TDC position and returning to the BDC position from the TDC position under the influence of gravity;
a rigid member connected to said piston and at least partially received in said slotted aperture, said rigid member engaging an end of said slotted aperture when said piston is at TDC so as to cause said piston to come to a stop;
a mass movably connected to said piston via a spring, said mass moving away from said piston and compressing said spring after said piston reaches TDC;
said cylinder defining an exhaust port disposed below TDC for allowing cylinder exhaust when said piston is at TDC;
a cylinder fluid intake including a valve in fluid communication with said cylinder bottom portion, said valve movable between a closed position and an open position, said valve including a actuating stem configured for actuating said valve when said piston reaches the BDC position;
said piston engaging said valve actuating stem upon returning to said BDC so as to actuate said valve to the open configuration whereby air from said compressed air source flows through said valve into said cylinder to initiate the working stroke;
a compressed air source in fluid communication with a first pressure vessel having an outlet in fluid communication with said cylinder fluid intake valve;
a liquid source in fluid communication with compressed air source for injecting at least some liquid into said cylinder fluid intake;
said piston engaging said valve actuating stem upon returning to said BDC so as to actuate said valve to the open configuration whereby air from said compressed air source flows through said valve into said cylinder to initiate the working stroke;
a booster pump having an inlet in fluid communication with said exhaust port, and an outlet, said booster pump configured for actuation as said piston returns to the BDC position;
a fin and tube heat exchanger having a tube inlet in fluid communication with the outlet of said booster pump, and a tube outlet;
a second pressure vessel having an inlet in fluid communication with said tube outlet, and an outlet;
a plurality of spaced check valves disposed in series within a fluid conduit assembly having an first end in fluid communication with said second pressure vessel outlet and a second end terminating at a T-connection having first and second outlets;
said first outlet in fluid communication with a manually actuated normally closed valve having an outlet in fluid communication with cylinder fluid intake, and a valve actuator configured to actuate the valve as said piston returns to the BDC position;
said second T-connection outlet in fluid communication with a manual valve having an outlet end in fluid communication with said first pressure vessel; and
whereby intermittent activation of said compressed air source provides a working fluid to drive said piston.

7. A reciprocating pneumatic piston gravity engine according to claim 6, wherein said liquid is water.

8. A reciprocating pneumatic piston gravity engine according to claim 6, wherein said first and second pressure vessels each include a fan.
